(19) United States
(12) Patent Application Publication
(10) Pub. No.: US 2010/0171886 A1
(43) Pub. Date: Jul. 8, 2010

(54) PRESENTATION OF READING SERVICE CHANNELS TO THE VISUALLY IMPAIRED

(76) Inventors: John Wm. Anderson, Highlands Ranch, CO (US); Neil Blank, Eldorado Springs, CO (US); David Farrell, Louisville, CO (US); Kirill Belyayev, Westminster, CO (US)

Correspondence Address: DUFT BORNSEN & FISHMAN, LLP, 1526 SPRUCE STREET, SUITE 302, BOULDER, CO, 80302, US

(21) Appl. No.: 12/350,803

(22) Filed: Jan. 8, 2009

(51) Int. Cl. H04N 5/50; G08B 25/08; H04N 7/173

(52) U.S. Cl. 348/732; 348/731; 340/692; 725/133; 348/E05.097

(57) ABSTRACT

Systems and methods are disclosed to automatically provide an audio sub-channel for a reading service to a visually impaired user. An audio service system includes a control module and a transmit module. The control module is operable to identify an audio sub-channel for a reading service available for reception within a broadcast area of a television content provider. The control module is further operable to identify a set of commands for a television tuner instructing the television tuner to tune to the audio sub-channel. The transmit module is operable to transmit the set of commands to the television tuner so the visually impaired user can listen to the audio sub-channel for the reading service.

### BACKGROUND OF THE INVENTION

1. Field of the Invention

The invention is related to the field of services for the visually impaired and, in particular, for automatically providing audio channels for reading services to the visually impaired.

2. Statement of the Problem

A visually impaired person faces many challenges in remaining informed in a world of visual media. While timely publications, such as newspapers, magazines, and other periodical print media provide a wealth of information to a media consumer, they may not be accessible to a visually impaired person. In some cases, print media may be available in Braille, which presents the print media to the visually impaired in a more accessible format. One problem with Braille translations of print media is that not all publications may be available in a Braille format. Another problem with Braille translations is that a delay may exist between the publication of the printed media and the translation. The delay in translating the printed media into Braille may render the information out of date by the time it is made available to the visually impaired.

Television broadcast stations may also provide services to the visually impaired using reading services. A reading service allows the visually impaired to hear various print media as it is read aloud. For example, a television broadcast station employee may read a local newspaper aloud on a specific television audio sub-channel. Thus, a visually impaired person can listen to the content of the local newspaper before it may become available in a Braille format.

Television broadcasters typically provide a number of different audio sub-channels of a television channel. For example, a television channel may include a number of audio sub-channels which provide English, Spanish, French, or other languages related to the content of the television channel. Reading services may also be provided by television broadcasters in different parts of the country in different ways. For example, in some parts of the country reading service channels may be provided on different audio sub-channels than in other parts of the country.

One problem with receiving reading services from television broadcasters is that a television decoder, such as a set top box, may need to be tuned to a specific audio sub-channel to receive the reading service. In some cases selecting a specific audio sub-channel on a set top box involves programming the set top box using a number of visual menus, which may be difficult for a visually impaired user to navigate. Another problem with receiving reading services arises when a visually impaired user travels with the set top box from one broadcast area to another. Because television broadcasters in different broadcast areas may utilize different audio sub-channels for the reading services, the set top box may need to be re-programmed to receive the new audio sub-channel.

### SUMMARY OF THE INVENTION

Embodiments of the invention automatically provide audio channels for a reading service to a visually impaired user. An audio service system, which is coupled to a television tuner, is operable to identify an audio sub-channel for a reading service in a broadcast area. The audio service system is further operable to identify a set of commands instructing the television tuner to tune to the identified audio sub-channel and to transmit the set of commands to the television tuner. In response to the set of commands, the television tuner navigates a number of on-screen menus to tune to the audio sub-channel so the visually impaired user can listen to the reading service. Because the reading service is automatically provided to the visually impaired user, the on-screen menus, which may be difficult for the visually impaired user to navigate, are automatically navigated by the audio service system.

One embodiment of the invention comprises an audio service system operable to automatically provide an audio sub-channel for a reading service to a visually impaired user. The audio service system includes a control module and a transmit module and is in communication with a television tuner. The control module is operable to identify an audio sub-channel for a reading service and a set of commands that instructs the television tuner to tune to the audio sub-channel. The transmit module is operable to transmit the set of commands to the television tuner. In response to the set of commands, the television tuner will tune to the audio sub-channel of the reading service so that the visually impaired user can listen to the audio sub-channel.

Another embodiment of the invention comprises a method of operating a set top box to automatically provide an audio sub-channel for a reading service to a visually impaired user. According to the method, an audio sub-channel for a reading service is identified. Additionally, a set of commands instructing a television tuner to tune to the audio sub-channel is identified. The set of commands is then transmitted to the television tuner. In response to the set of commands, the television tuner will tune to the audio sub-channel so that the visually impaired user can listen to the audio sub-channel.

The invention may include other exemplary embodiments described below.

### DESCRIPTION OF THE DRAWINGS

The same reference number represents the same element or same type of element on all drawings.

FIG. 1 illustrates an audio service system in an exemplary embodiment of the invention.

FIG. 2 is a flowchart illustrating a method of operating a set top box including an audio service system in an exemplary embodiment of the invention.

FIG. 3 illustrates an example of on-screen menu navigation presented by a television tuner to select and tune to an audio sub-channel.

FIG. 4 is a flowchart illustrating a method of performing a channel scan function within a television tuner in an exemplary embodiment of the invention.

FIG. 5 illustrates a front view of a set top box including an audio service system in an exemplary embodiment of the invention.

FIG. 6 illustrates a rear view of the set top box of FIG. 5 in an exemplary embodiment of the invention.

FIG. 7 illustrates a bottom view of the set top box of FIG. 5 in an exemplary embodiment of the invention.

FIG. 8 illustrates an internal view of the set top box of FIG. 5 in an exemplary embodiment of the invention.

### DETAILED DESCRIPTION OF THE INVENTION

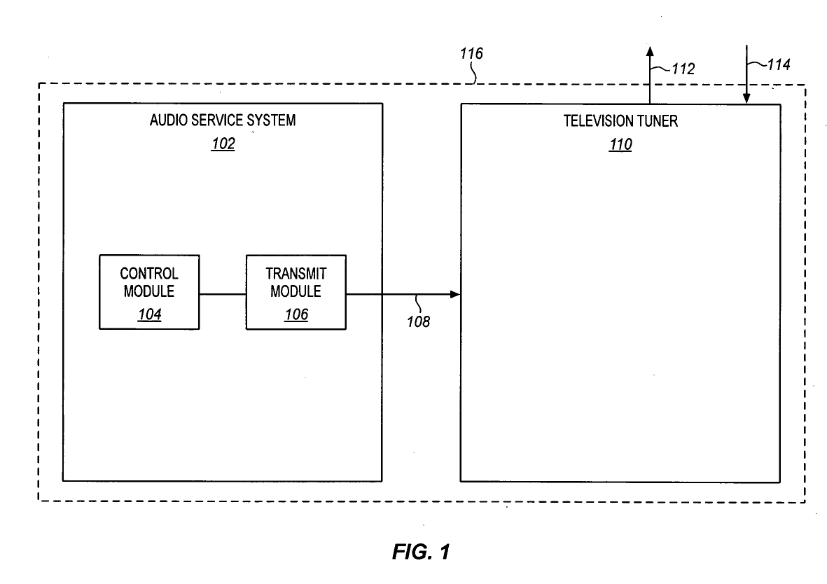

FIGS. 1-2, 4-8, and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an audio service system 102 coupled to a television tuner 110 in an exemplary embodiment of the invention. Audio service system 102 may be part of another system, such as a set top box, as indicated by a dashed line 116. Television tuner 110 receives broadcast signals 114 from a television content provider from a variety of sources such as over the air television broadcasts, cable television providers, and satellite television providers. Broadcast signals 114 are decoded by television tuner 110 into television channels, where one or more television channels include audio sub-channels. One of the television channels includes an audio sub-channel for a reading service for the visually impaired.

In this embodiment, audio service system 102 includes a control module 104 and a transmit module 106. Control module 104 may comprise any system, hardware, or software operable to identify an audio sub-channel for a reading service and to identify a set of commands for television tuner 110. The set of commands includes one or more commands that instruct television tuner 110 to tune to the audio sub-channel of the reading service. Control module 104 may identify the set of commands for television tuner 110 in a number of ways, such as determining a specific model of television tuner 110 which indicates to control module 104 a specific layout of on-screen menus used when instructing television tuner 110 to tune to the audio sub-channel.

Transmit module 106 may comprise any system, hardware, or software operable to transmit the set of commands along a signal path 108 to television tuner 110, so that a visually impaired user can listen to the audio sub-channel. When transmit module 106 transmits the set of commands to television tuner 110 along signal path 108, a number of wired or wireless interfaces may be used. Transmit module 106 may transmit the set of commands using wired interfaces, such as a recommended standard 232 (RS-232) interface, or a system packet interface (SPI). Transmit module 106 may alternatively transmit the set of commands using wireless interfaces, such as a radio frequency (RF) interface or an infra-red (IR) interface. Television tuner 110, responsive to receiving the set of commands, may process the commands to tune to the audio sub-channel for the reading service based on a number of broadcast signals 114 received. Television tuner 110 may then provide the audio sub-channel to the visually impaired user along audio output 112, so that the visually impaired user can listen to the audio sub-channel for the reading service. Audio output 112 may be presented to additional electronic equipment, such as a stereo system. Additionally, audio service system 102 may include an audio output module operable to receive the audio sub-channel from television tuner 110.

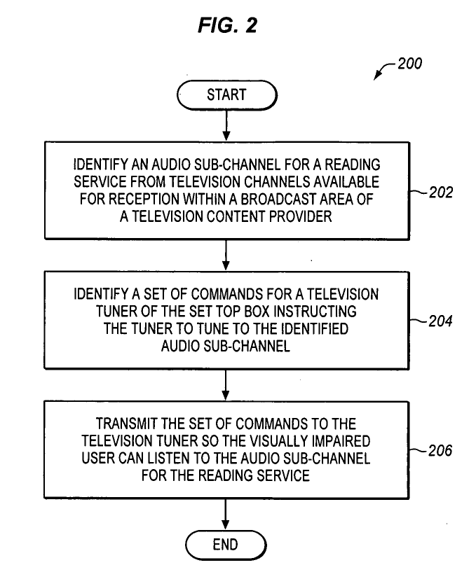

FIG. 2 is a flowchart illustrating a method 200 of operating a set top box 116 including an audio service system 102 in an exemplary embodiment of the invention. The steps shown in method 200 are not all inclusive and may include other steps not illustrated. The steps of method 200 will be discussed with reference to audio service system 102 illustrated in FIG. 1, but those skilled in the art will understand that method 200 may be performed by other systems.

In step 202, control module 104 identifies an audio sub-channel for a reading service in a broadcast area. Television stations broadcast within a specific area, known as a broadcast area. For example, a broadcast area may include a roughly circular area of about 50 miles around an antenna being used by a television station when broadcasting television channels. The broadcast area may depend on a number of factors, including the signal power of the television station, the weather, and the type of terrain around the broadcast station. Additionally, a broadcast area may include geographical areas which are provided television content. For example, a cable provider in a metropolitan area may provide similar broadcast content to all of its subscribers within the metropolitan area. In other cases, a content provider may provide similar broadcast content to all of its subscribers regardless of where the subscribers are located. One example of this may be a national broadcast channel, such as cable news network.

In step 204, control module 104 identifies a set of commands for television tuner 110 for instructing television tuner 110 to tune to the audio sub-channel. When identifying the set of commands, control module 104 may determine a pre-provisioned set of commands based on the model and type of television tuner 110. Because different models and types of television tuner 110 may include different commands for navigating through menus, control module 104 may store a number of sets of commands in order to correctly identify the set of commands specific to television tuner 110. When control module 104 identifies the set of commands, the commands instruct television tuner 110 to navigate through various on-screen menus in order to correctly tune to the audio sub-channel.

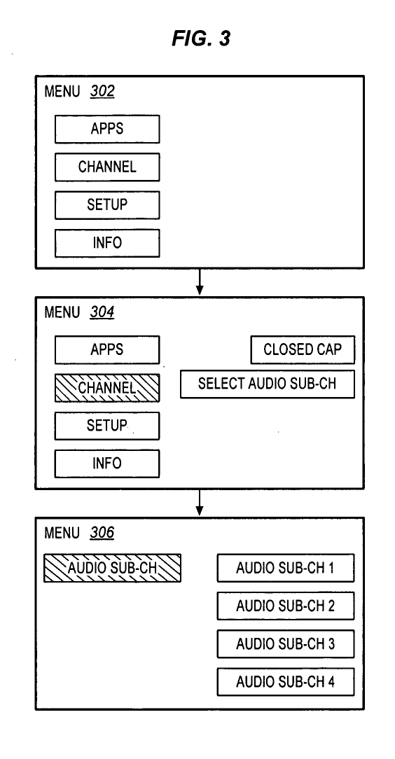

FIG. 3 illustrates an example of on-screen menus which may be presented by television tuner 110 to select and tune to an audio sub-channel. The menus represent an example of the types of menus that a user would have to navigate to select and tune to an audio sub-channel.

Menu 302 illustrates a top level on-screen menu for television tuner 110. Menu 302 includes an option for a user to select and control specific channel functionality of television tuner 110. A user, through a remote control for example, transmits a first command to select the channel function to instruct television tuner 110 to navigate to a channel menu as illustrated by menu 304.

Menu 304 illustrates a second menu of on-screen options which may be presented by television tuner 110 after a user transmits the first command to select the channel option from menu 302. Menu 304 may allow a user to enable a closed captioning option or select a specific audio sub-channel to tune to. When a user wishes to select a specific audio sub-channel, the user selects the “select audio sub-ch” option displayed on menu 304 by transmitting a second command. The second command instructs television tuner 110 to navigate to an audio sub-channel menu illustrated by menu 306.

Menu 306 illustrates a third menu of on-screen options which may be presented by television tuner 110, after the user navigates through menus 302-304 as described above. In menu 306, television tuner 110 displays options for selecting a specific audio sub-channel, such as audio sub-channels 1-4 illustrated in menu 306. The user may then select audio sub-channel 4 by transmitting a third command to television tuner 110, which instructs television tuner 110 to tune to audio sub-channel 4.

In step 206 of FIG. 2, transmit module 106 transmits the set of commands to television tuner 110 so that the visually impaired user can listen to the audio sub-channel. The commands, when received by television tuner 110, instruct television tuner 110 to select and tune to the audio sub-channel. For example, the set of commands may instruct television tuner 110 to navigate through menus 302-306 similar to how the user navigated manually as described with respect to FIG. 3. The commands may also include pauses or delays, which may allow television tuner 110 time to switch from one menu to another menu.

Because audio service system 102 automatically tunes to the audio sub-channel for the reading service, the visually impaired user does not have to manually navigate on-screen menus for controlling television tuner 110, which can present problems for visually impaired user 114.

In some cases, television tuner 110 may scan through the channels it receives from broadcast signals 114 in order to determine television channels available for reception within the broadcast area. For example, after television tuner 110 is assembled, television tuner 110 may be shipped to any number of different broadcast areas, each of which may have different channels available for reception. A channel scan function performed by television tuner 110 allows television tuner 110 to determine which broadcast signals 114 are available for reception within the broadcast area. In some cases, television tuner 110 may not be operable to select a specific channel to tune to before a channel scan function determines which channels are available for reception. Therefore, a channel scan function may be performed by television tuner 110 before method 200 of FIG. 2 is performed.

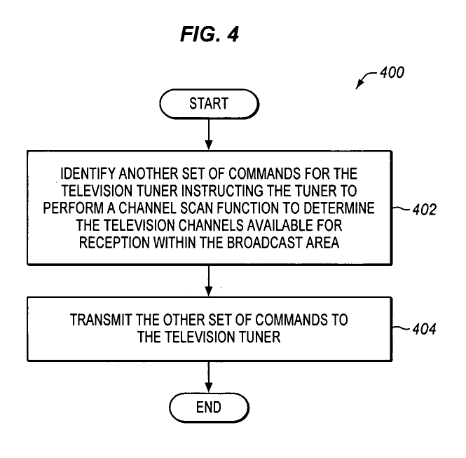

FIG. 4 is a flowchart illustrating a method 400 of performing a channel scan function within television tuner 110 in an exemplary embodiment of the invention. The steps of method 400 are not all inclusive and may include other steps not illustrated. Method 400 will be discussed with reference to audio service system 102 illustrated in FIG. 1, but those skilled in the art will understand that method 400 may be performed by other systems.

In step 402, control module 104 identifies another set of commands instructing television tuner 110 to perform a channel scan function. When identifying the other set of commands, control module 104 may determine a pre-provisioned set of commands based on the model and type of television tuner 110. Because different models and types of television tuner 110 may include different commands for navigating through menus, control module 104 may store a number of sets of commands in order to identify the correct set of commands specific to television tuner 110.

In step 404, transmit module 106 transmits the other set of commands along signal path 108 to television tuner 110. In response to receiving the other set of commands, television tuner 110 navigates through menus similar to how a user would navigate manually in order to instruct television tuner 110 to perform the channel scan function. In response to television tuner 110 performing the channel scan function, audio service system 102 may instruct television tuner 110 to tune to an audio sub-channel for a reading service using method 200 of FIG. 2.

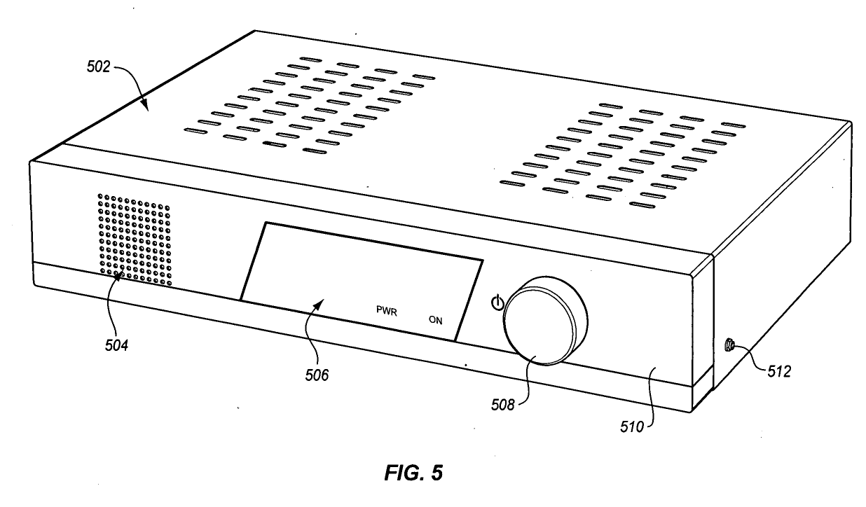

As mentioned above, audio service system 102 may be implemented in a set top box. One particular embodiment of a set top box is illustrated in FIGS. 5-8.

FIG. 5 illustrates a front view of a set top box 502 in an exemplary embodiment of the invention. Set top box 502 automatically provides an audio sub-channel for a reading service to a visually impaired user. Set top box 502 includes a speaker grill 504, and a front display window 506, located on a front panel 510, a volume knob 508, and a headphone jack 512. Volume knob 508 operates to modify an internal volume control module (not shown) to alter the volume of an internal speaker. Display window 506 allows IR signals from a remote control (not shown) to be transmitted through display window 506 to a wireless receiver (not shown) internal to set top box 502.

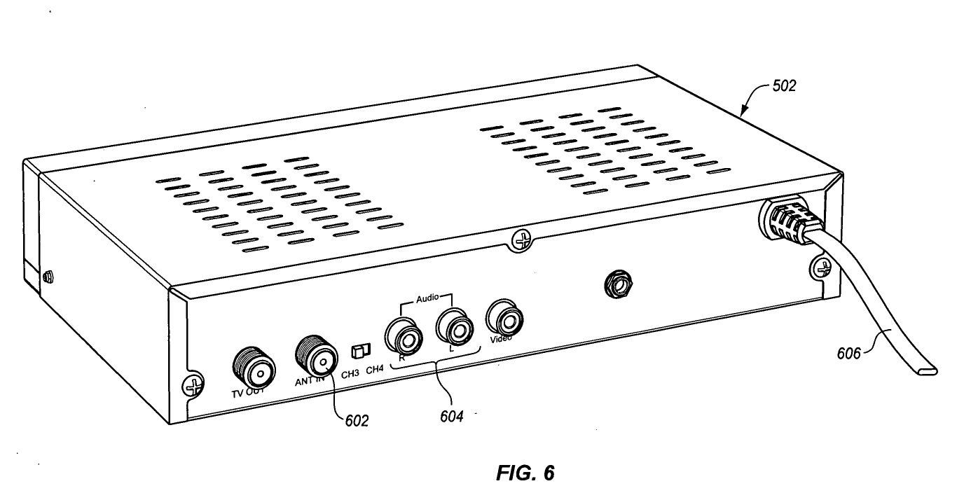

FIG. 6 illustrates a rear view of set top box 502 in an exemplary embodiment of the invention. The rear view of set top box 502 illustrates an antenna connection 602, audio connections 604, and a power cord 606.

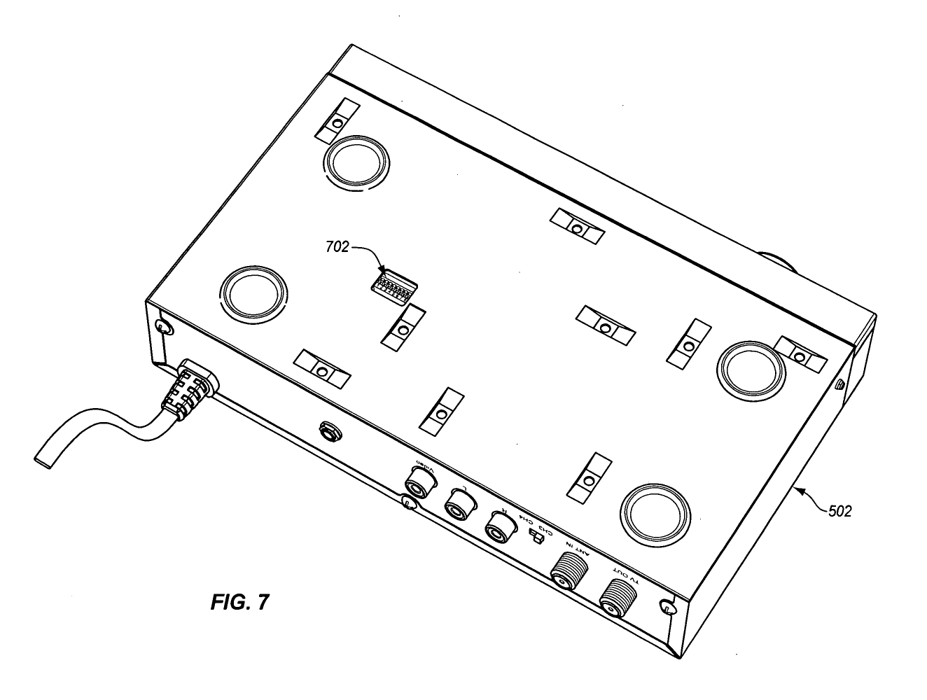

FIG. 7 illustrates a bottom view of set top box 502 in an exemplary embodiment of the invention. The bottom view of set top box 502 illustrates a dip switch 702. Dip switch 702 may include a number of preset switch positions to indicate a specific audio sub-channel for the reading service. For example, dip switch 702 may include multiple binary positions (n) which indicate 2̂n possible audio sub-channels.

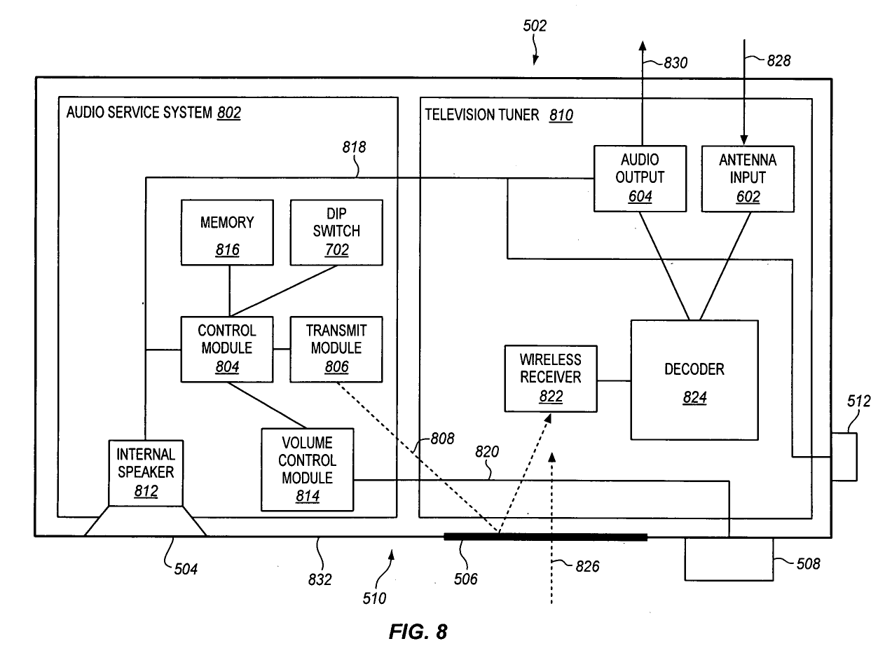

FIG. 8 illustrates an internal view of set top box 502 in an exemplary embodiment of the invention. Set top box 502 may be included as part of other systems, such as a stereo system, cable system, a direct TV system, or other systems operable to provide television signals to set top box 502. For example, antenna input 602 (see FIG. 6) may receive television signals from a local cable service or an over the air antenna. Set top box 502 includes an enclosure 832 housing an audio service system 802 and a television tuner 810. Audio service system 802 includes a control module 804, a transmit module 806, an internal speaker 812, a memory 816, and a volume control module 814.

Set top box 502 is operable to perform an automatic tuning function to tune to an audio sub-channel for a reading service. In some cases, the automatic tuning function may be performed in response to a trigger event, such as when volume knob 508 is “off” when power is applied to set top box 502. In some cases, control module 804 will determine the power status of television tuner 810 by measuring a light emitting diode to determine the power on status of television tuner 810. To begin the automatic tuning process, control module 804 identifies an audio sub-channel for the reading service. For example, after manufacturing set top box 502 and before set top box 502 is shipped to a visually impaired user, a television broadcast station may program dip switch 702 with the audio sub-channel for the reading service within the broadcast area. Control module 804 may thus “read” dip switch 702 to identify the audio sub-channel for the reading service for that broadcast area. Additionally, control module 804 may identify the audio sub-channel for the reading service using information received from the television content provider, a network connection to the internet, or by using other means.

Control module 804 identifies the set of commands for television tuner 810 to instruct television tuner 810 to tune to the audio sub-channel for the reading service. When identifying the set of commands, control module 104 may read a pre-provisioned table of commands that are stored in memory 816. The pre-provisioned commands may be specific to the make, model, firmware revision, or other information related to television tuner 810. For example, control module 802 may identify a specific model of television tuner 810 in order to identify the set of commands for television tuner 810 by communicating with television tuner 110, by reading a switch indicating the specific model of television tuner 810, or by other means of identifying television tuner 810.

In response to control module 804 identifying the sets of commands for television tuner 810, transmit module 806 transmits the sets of commands along a signal path 808 to a wireless receiver 822 within television tuner 810. Commands sent along signal path 808 intersect and reflect off of an inside surface of display window 506 and are received by wireless receiver 822.

Because wireless receiver 822 receives commands in a similar manner along both signal paths 826 and 808, television tuner 810 may not necessarily distinguish commands sent along signal paths 826 and 808. For example, audio service system 802 may send commands to television tuner 810 which are substantially similar to commands sent to television tuner 810 by an external remote control. Thus, television tuner 810 may be substantially similar to television tuners included in set top boxes that do not include audio service system 802. This may advantageously allow audio service system 802 to be retro-fitted to a variety of set top boxes which include television tuner 810 without modifying television tuner 810.

In response to receiving the set of commands, television tuner 810 tunes to the audio sub-channel so that the visually impaired user may listen to the audio sub-channel. Broadcast signals 828 received at antenna input 602 are decoded by a decoder 824 into a plurality of television channels. At least one of the television channels includes an audio sub-channel for the reading service. Responsive to tuning to the audio sub-channel for the reading service, decoder 824 transmits audio for the reading service to audio output 604. An audio output path 818 allows internal speaker 812 and headphone jack 512 to present the reading channel to the visually impaired user. Additionally, the visually impaired user may listen to the audio sub-channel for the reading service using audio output path 830, which may be connected to an external stereo system. Volume control knob 508 modifies volume control module 814 to allow the visually impaired user to alter the volume of the audio sub-channel output on internal speaker 812 and/or headphone jack 512.

In some cases, television tuner 810 may generate a delay while tuning to the audio sub-channel for the reading service. In this case, control module 804 may generate an audio alert tone using internal speaker 812 and/or headphone jack 512 to indicate to the visually impaired user that set top box 502 is busy tuning to the audio sub-channel.

Audio service system 802 is further operable to instruct television tuner 810 to perform a channel scan function. In some cases, the channel scan function may be performed in response to a trigger event, such as when volume knob 508 is “on” when power is applied to set top box 502. To begin the automatic channel scan function, control module 804 identifies another set of commands for instructing television tuner 810 to perform a channel scan function.

In response to control module 804 identifying the other sets of commands for television tuner 810, transmit module 806 transmits the other set of commands along signal path 808 to wireless receiver 822. In response to receiving the other set of commands, television tuner 810 performs the channel scan function. In some cases when performing the channel scan function, television tuner 810 may generate a delay. In order to inform the visually impaired user of the delay, an audio alert may be generated in a manner similar to the audio alert generated while tuning to the audio sub-channel for the reading service.

Although audio service system 102 and set top box 502 have been described in terms of “modules”, one skilled in the art will recognize that various embodiments of audio service system 102 and set top box 502 may exist, such as embodiments in software, hardware, computer instructions executing on a processing system, electronic circuits, random access memory (RAM), read only memory (ROM), programmable logic, or other hardware or software implementations. Recitation of “modules” when describing the operation of audio service system 102 and set top box 502 does not imply or limit the embodiments to any specific hardware or software implementation.

Although specific embodiments were described herein, the scope of the invention is not limited to those specific embodiments. The scope of the invention is defined by the following claims and any equivalents thereof

We claim:

1. An audio service system operable to automatically provide an audio sub-channel for a reading service to a visually impaired user, the audio service system comprising:
a control module operable to identify an audio sub-channel for a reading service from television channels available for reception within a broadcast area of a television content provider, and to identify a set of commands for a television tuner instructing the television tuner to tune to the audio sub-channel; and
a transmit module operable to transmit the set of commands to the television tuner so the visually impaired user can listen to the audio sub-channel for the reading service.

2. The audio service system of claim 1 wherein:
the control module, responsive to a trigger event, is further operable to identify another set of commands for the television tuner instructing the television tuner to perform a channel scan function to determine the television channels available for reception within the broadcast area; and
the transmit module is further operable to transmit the other set of commands to the television tuner.

3. The audio service system of claim 2 wherein:
the audio service system further comprises an audio output module operable to receive the audio sub-channel from the television tuner and to provide the audio sub-channel to the visually impaired user; and
the audio output module, responsive to the transmission of the other set of commands, is further operable to generate an audio alert indicating that the channel scan function is being performed.

4. The audio service system of claim 2 further comprising:
an internal speaker operable to receive the audio sub-channel from the television tuner and to provide the audio sub-channel to the visually impaired user; and
a volume control module operable to modify a volume of the internal speaker.

5. The audio service system of claim 4 wherein the trigger event includes determining that the volume control module is on when power is applied to the audio service system.

6. The audio service system of claim 1 wherein the transmit module is further operable to transmit the set of commands to the television tuner through a wireless interface using one of radio frequency (RF) signals and infra-red (IR) signals.

7. The audio service system of claim 1 wherein the transmit module is further operable to transmit the set of commands to the television tuner through a wired interface using one of RS-232 (Recommended Standard 232) signals and SPI (System Packet Interface) signals.

8. A set top box operable to automatically provide an audio sub-channel for a reading service to a visually impaired user, the set top box comprising:
an enclosure housing a television tuner; and
an audio service system within the enclosure comprising:
a control module operable to identify an audio sub-channel for a reading service from television channels available for reception within a broadcast area of a television content provider, and to identify a set of commands for the television tuner instructing the television tuner to tune to the audio sub-channel; and
a transmit module operable to transmit the set of commands within the enclosure to the television tuner through wireless signals, so the visually impaired user can listen to the audio sub-channel for the reading service.

9. The set top box of claim 8 wherein:
the enclosure further comprises a reflective surface; and
the transmit module is further operable to transmit the wireless signals off of the reflective surface to a wireless receiver of the television tuner.

10. The set top box of claim 9 wherein:
the reflective surface is oriented along a front panel of the enclosure facing the wireless receiver of the television tuner; and
the wireless signals comprise infra-red (IR) signals.

11. The set top box of claim 8 wherein the audio service system further comprises:
an internal speaker operable to receive the audio sub-channel from the television tuner and to provide the audio sub-channel for the reading service to the visually impaired user; and
a volume control module operable to modify a volume of the internal speaker.

12. The set top box of claim 8 wherein the audio service system further comprises:
a dip switch programmed with the audio sub-channel for the reading service within the broadcast area; and
the control module is further operable to identify the audio sub-channel based on the dip switch.

13. The set top box system of claim 8 wherein the transmit module is further operable to transmit the set of commands to the television tuner using radio frequency (RF) signals.

14. The set top box system of claim 8 wherein an audio output module, responsive to the transmission of the set of commands, is operable to generate an audio alert indicating that the television tuner is tuning to the audio sub-channel.

15. The set top box system of claim 8 wherein the audio service system further comprises:
the control module, responsive to a trigger event, is further operable to identify another set of commands for the television tuner instructing the television tuner to perform a channel scan function to determine television channels available for reception in the broadcast area; and
the transmit module is further operable to transmit the other set of commands to the television tuner.

16. The set top box system of claim 15 wherein the trigger event includes determining that a volume control module is on when power is applied to the set top box system.

17. The set top box system of claim 15 wherein an audio output module, responsive to the transmission of the other set of commands, is operable to generate an audio alert indicating that the channel scan function is being performed.

18. A method of operating a set top box to automatically provide an audio sub-channel for a reading service to a visually impaired user, the method comprising:
identifying, in an audio service system of the set top box, an audio sub-channel for a reading service from television channels available for reception within a broadcast area of a television content provider;
identifying, in the audio service system, a set of commands for a television tuner of the set top box instructing the television tuner to tune to the identified audio sub-channel; and
transmitting the set of commands from the audio service system to the television tuner, so the visually impaired user can listen to the audio sub-channel for the reading service.

19. The method of claim 18 further comprising:
identifying, in the reading service system, another set of commands for the television tuner instructing the television tuner to perform a channel scan function to determine television channels available for reception in the broadcast area; and
transmitting the other set of commands to the television tuner.

20. The method of claim 19 wherein identifying the other set of commands is performed in response to:
determining, in the audio service system, if a volume control module is on when power is applied to the set top box.

21. The method of claim 19 further comprising:
generating an audio alert indicating that the channel scan function is being performed.

22. The method of claim 18 wherein transmitting the set of commands to the television tuner includes transmitting the commands using one of radio frequency (RF) signals and infra-red (IR) signals.

23. The method of claim 18 wherein transmitting the commands to the television tuner includes transmitting the commands using one of RS-232 (Recommended Standard 232) signals and SPI (System Packet Interface) signals.

24. The method of claim 18 further comprising:
generating an audio alert indicating that the television tuner is tuning to the audio sub-channel.
